(19) United States
(12) Patent Application Publication
(10) Pub. No.: US 2022/0374745 A1
(43) Pub. Date: Nov. 24, 2022

(54) ELECTRONIC DEVICE AND METHOD FOR SCORING DRIVING BEHAVIOR USING VEHICLE INPUTS AND OUTPUTS

(71) Applicant: GUANGZHOU AUTOMOBILE GROUP CO., LTD., Guangzhou (CN)

(72) Inventors: KILSOO KIM, Sunnyvale, CA (US); Yiwen GUO, Sunnyvale, CA (US); Wenqi YANG, Guangzhou (CN); Yonggang XU, Los Gatos, CA (US)

(21) Appl. No.: 17/323,327

(22) Filed: May 18, 2021

(51) Int. Cl. G06N 7/00

(52) U.S. Cl. CPC G06N 7/00; G07C 5/008

(57) ABSTRACT

A method for scoring driving behavior using vehicle inputs and outputs is implemented in an electronic device. The method includes obtaining historical input data and output data of a vehicle; establishing an output regression model according to the historical output data; determining a boundary of the output regression model; establishing an input regression model according to the historical input data; determining a boundary of the input regression model by calculating boundary limits of the input regression model; obtaining real-time input data and output data of the vehicle; calculating a first ratio of data points outside the boundary of the input regression model to total data points in the real-time input data, and a second ratio of data points outside the boundary of the output regression model to total data points in the real-time output data; scoring driving behavior of a driver according to the first ratio and the second ratio.

### FIELD

The subject matter herein generally relates to driving behavior identification, and particularly to an electronic device and a method for scoring driving behavior using vehicle inputs and outputs.

### BACKGROUND

Driving behavior is identified and analyzed to improve driving safety. Various environmental sensors, such as cameras, radars, lidars, GPS sensors, are usually utilized to detect vehicle outputs, and the driving behavior is identified according to the vehicle outputs. However, the driving behavior depends on not only the vehicle outputs but also vehicle inputs from drivers, the vehicle inputs from the drivers and a relation between the vehicle inputs and the vehicle outputs has not been considered in driving behavior identification.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a schematic view of an embodiment of an application environment of an electronic device according to the present disclosure.

FIG. 2 illustrates a flowchart of an embodiment of a method for scoring driving behavior using vehicle inputs and outputs according to the present disclosure.

FIG. 3 illustrates a flowchart of an embodiment of steps of establishing an output regression model of the vehicle according to the present disclosure.

FIG. 4 is a schematic view of an embodiment of a three-dimensional coordinate system according to the present disclosure.

FIG. 5 illustrates a flowchart of an embodiment of steps of determining a boundary of the output regression model according to the present disclosure.

FIG. 6 illustrates a flowchart of an embodiment of steps of establishing an input regression model of the vehicle according to the present disclosure.

FIG. 7 is a schematic view of an embodiment of a coordinate system according to the present disclosure.

FIG. 8 illustrates a flowchart of an embodiment of steps of determining a boundary of the input regression model according to the present disclosure.

FIG. 9 is a schematic view of an embodiment of data points in real-time input data according to the present disclosure.

FIG. 10 is a schematic view of an embodiment of data points in real-time output data according to the present disclosure.

FIG. 11 is a block diagram of an embodiment of an electronic device according to the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

The present disclosure, including the accompanying drawings, is illustrated by way of examples and not by way of limitation. Several definitions that apply throughout this disclosure will now be presented. It should be noted that references to “an” or “one” embodiment in this disclosure are not necessarily to the same embodiment, and such references mean “at least one.”

Furthermore, the term “module”, as used herein, refers to logic embodied in hardware or firmware, or to a collection of software instructions, written in a programming language, such as Java, C, or assembly. One or more software instructions in the modules can be embedded in firmware, such as in an EPROM. The modules described herein can be implemented as either software and/or hardware modules and can be stored in any type of non-transitory computer-readable medium or another storage device. Some non-limiting examples of non-transitory computer-readable media include CDs, DVDs, BLU-RAY, flash memory, and hard disk drives. The term “comprising” means “including, but not necessarily limited to”; it in detail indicates open-ended inclusion or membership in a so-described combination, group, series, and the like.

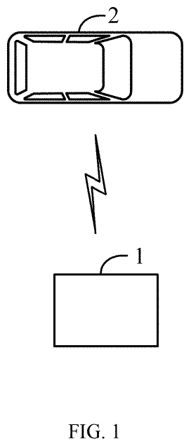

Referring to FIG. 1, an electronic device 1 which can communicate with a vehicle 2 is illustrated. In one embodiment, the electronic device 1 communicates with the vehicle 2 through a wire network or a wireless network. The wireless network can be radio, WI-FI, or cellular network. The wire network can be a CAN (Controller Area Network) bus.

In one embodiment, the electronic device 1 can be a personal computer or a server, the electronic device 1 communicates with the CAN bus of the vehicle 2, and transmits or receives data through the CAN bus. In other embodiments, the electronic device 1 can be a unit arranged in the vehicle 2 and coupled with the CAN bus. In other embodiments, the electronic device 1 can be the vehicle 2 itself.

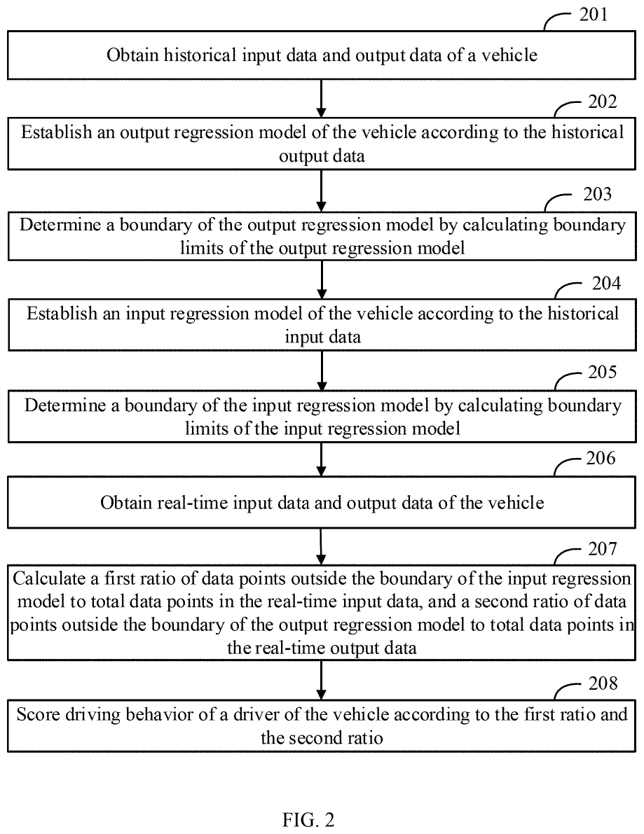

FIG. 2 illustrates a flowchart of an embodiment of a method for scoring driving behavior using vehicle inputs and outputs. The method is provided by way of example, as there are a variety of ways to carry out the method. Each block shown in FIG. 2 represents one or more processes, methods, or subroutines carried out in the example method. Furthermore, the illustrated order of blocks is by example only and the order of the blocks can be changed. Additional blocks may be added or fewer blocks may be utilized, without departing from this disclosure. The example method can begin at block 201.

At block 201, obtain historical input data and output data of the vehicle 2.

In one embodiment, input data of the vehicle 2 is generated by in response to driver operations, the driver operations can include turning a steering wheel of the vehicle 2 and pressing a pedal of the vehicle 2. The input data at least includes steering wheel angles, braking pedal positions, and acceleration pedal positions, the braking pedal position and the acceleration pedal position are in percent. The output data at least includes velocities, longitudinal accelerations, lateral accelerations, and yaw rates of the vehicle 2, the yaw rate is in rad/s. The input data and output data can be detected by sensors of the vehicle 2, and collected by the CAN bus of the vehicle 2.

In one embodiment, the historical input data and the historical output data can be collected by the CAN bus within a first predefined time period, and obtained from the CAN bus. The first predefined time period can be a day, a week, or a month.

At block 202, establish an output regression model of the vehicle 2 according to the historical output data.

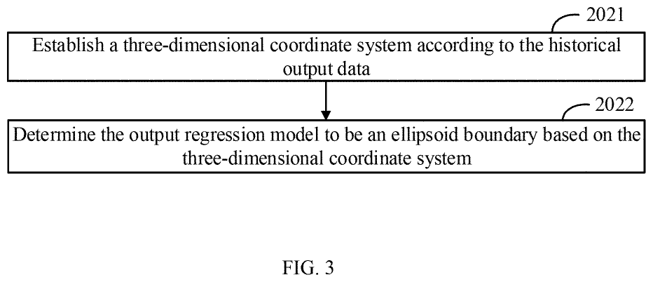

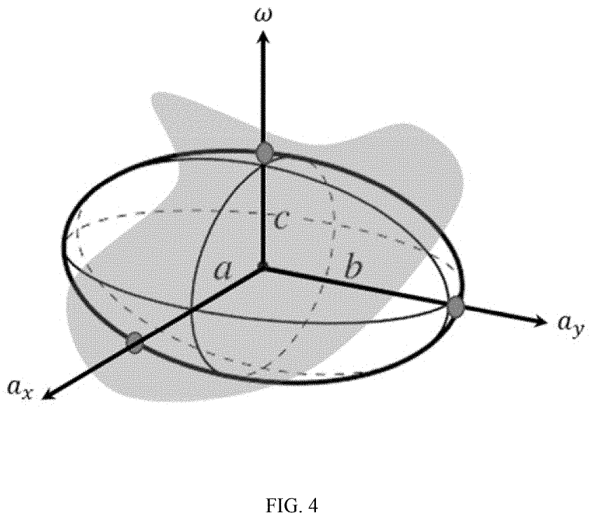

Referring to FIG. 3, at block 2021, establish a three-dimensional coordinate system according to the historical output data. Referring to FIG. 4, in one embodiment, an x-axis of the three-dimensional coordinate system records the longitudinal accelerations, a y-axis of the three-dimensional coordinate system records the lateral accelerations, and a z-axis of the three-dimensional coordinate system records the yaw rates.

In one embodiment, at block 2022, determine the output regression model to be an ellipsoid boundary based on the three-dimensional coordinate system. The output regression model is expressed by the following equation (1):

$$1 = {( \frac{{a}_{x}}{a} )}^{2} + {( \frac{{a}_{y}}{b} )}^{2} + {( \frac{ω}{c} )}^{2} . \qquad ( 1 )$$

In the equation (1), aₓ is the longitudinal acceleration, a_{y} is the lateral acceleration, w is the yaw rate, a is an intercept on the x-axis, b is an intercept on the y-axis, c is an intercept on the z-axis.

At block 203, determine a boundary of the output regression model by calculating boundary limits of the output regression model.

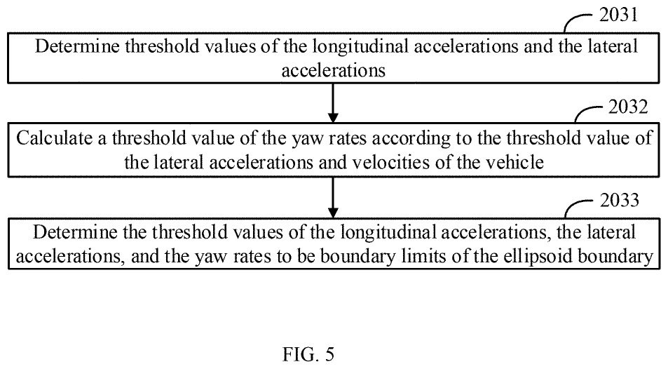

Referring to FIG. 5, At block 2031, determine threshold values of the longitudinal accelerations and the lateral accelerations. In one embodiment, The intercepts a, b, and c are the boundary limits of the output regression model, at the same time, a is a threshold value of the longitudinal accelerations, b is a threshold value of the lateral accelerations, c is a threshold value of the yaw rates. In one embodiment, the threshold value of the longitudinal accelerations can be determined to be a_{x,limit} according to ISO specifications, and the threshold value of the lateral accelerations can be determined to be a_{y,limit} according to ISO specifications.

That is, |aₓ|≤a_{x,limit}, |a_{y}|≤a_{y,limit}, a=a_{x,limit}, b=a_{y,limit}.

At block 2032, calculate a threshold value of the yaw rates according to the threshold value of the lateral accelerations and velocities of the vehicle. In one embodiment, a relation between the yaw rate w, the lateral acceleration a_{y}, and velocity vₓ of the vehicle 2 can be expressed by the following equation (2) according to kinematics:

$$ω = \frac{{a}_{y}}{{v}_{x}} . \qquad ( 2 )$$

According to the equation (2) and

$$\vert {a}_{y} \vert \leq {a}_{y , limit} , \vert ω \vert \leq \frac{{a}_{y , limit}}{{v}_{x}} .$$

At block 2033, determine the threshold values of the longitudinal accelerations, the lateral accelerations, and the yaw rates to be boundary limits of the ellipsoid boundary. As illustrated in FIG. 4, in one embodiment, the ellipsoid boundary can be determined according to the boundary limits, that is, the threshold value a of the longitudinal accelerations, the threshold value b of the lateral accelerations, and the threshold value c of the yaw rates.

At block 204, establish an input regression model of the vehicle 2 according to the historical input data.

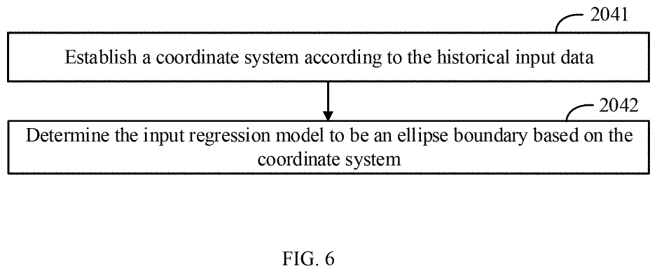

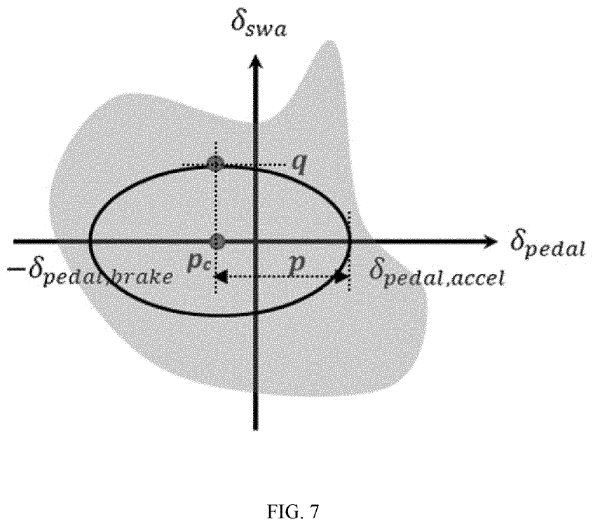

Referring to FIG. 6, at block 2041, establish a coordinate system according to the historical input data. Referring to FIG. 7, an x-axis of the coordinate system records pedal positions, and a y-axis of the coordinate system records the steering wheel angles.

At block 2042, determine the input regression model to be an ellipse boundary based on the coordinate system. The output regression model is expressed by the following equation (3):

$$1 = {( \frac{{δ}_{pedal}}{p} - {p}_{c} )}^{2} + {( \frac{{δ}_{swa}}{q} )}^{2} . \qquad ( 3 )$$

In the equation (3), δ_{swa} is the steering wheel angle, δ_{pedal} is the braking or acceleration pedal position, δ_{pedal} ϵ[−δ_{pedal,brake}, δ_{pedal,accel}], p_{c} is an offset in a pedal axis, p is an intercept on the x-axis, q is an intercept on the y-axis. In one embodiment, the braking pedal position is set as negative, and the acceleration pedal position is set as positive, so that the pedal position ranges from negative to positive in the x-axis of the coordinate system.

At block 205, determine a boundary of the input regression model by calculating boundary limits of the input regression model.

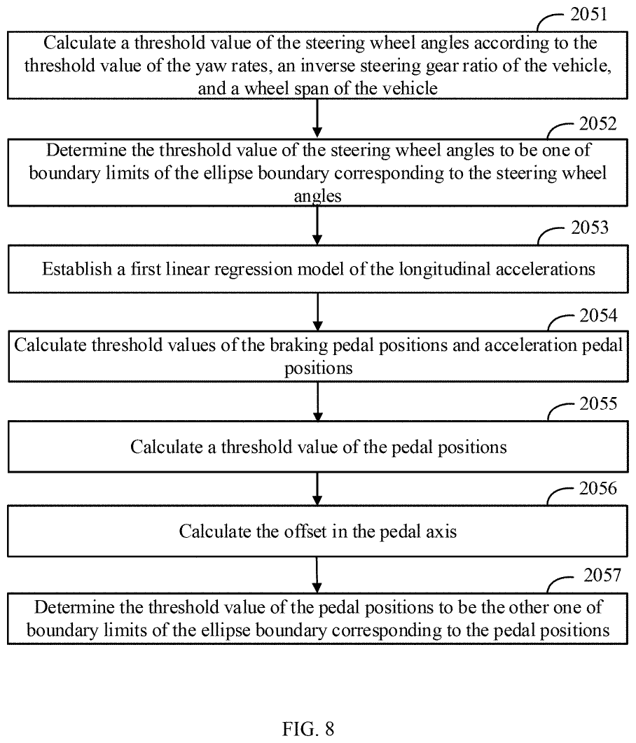

Referring to FIG. 8, at block 2051, calculate a threshold value of the steering wheel angles according to the threshold value of the yaw rates, an inverse steering gear ratio of the vehicle 2, and a wheel span of the vehicle 2.

In one embodiment, the intercept q on the y-axis is equal to the threshold value of the steering wheel angles, a relation between the steering wheel angles δ_{swa}, the yaw rates w, an inverse steering gear ratio i of the vehicle 2, and a wheel span L of the vehicle 2 can be expressed by the following equation (4) according to kinematics.

δ_{swa}=i_{w}atan(Lω) (4)

According the equation (4) and

$$\vert ω \vert \leq \frac{{a}_{y , limit}}{{v}_{x}} , {δ}_{swa} \leq {i}_{w} a tan ( L \frac{{a}_{y , limit}}{{v}_{x}} ) .$$

At block 2052, determine the threshold value of the steering wheel angles to be one of boundary limits of the ellipse boundary corresponding to the steering wheel angles. In one embodiment, δ_{swa,limit}=q, thus,

$$q = {i}_{w} a tan ( L \frac{{a}_{y , limit}}{{v}_{x}} ) .$$

At block 2053, establish a first linear regression model of the longitudinal accelerations according to a relation between the longitudinal acceleration aₓ, the pedal positions δ_{swa}, and the velocities vₓ of the vehicle 2.

In one embodiment, the relation between the longitudinal acceleration, the pedal positions, and the velocities of the vehicle can be expressed by the following equation (5):

aₓ=fₓ(δ_{pedal}, vₓ) (5)

In the equation (5), the function fₓ is monotonic and can be fitted into the first linear regression model. The first linear regression model can be expressed by the following linear fitting equation (6):

$${f}_{x} ( {δ}_{pedal} , {v}_{x} ) = {w}_{0} + {\sum }_{j = 1}^{n} {w}_{j} {ϕ}_{j} ( X ) . \qquad ( 6 )$$

In the equation (6), ϕⱼ(X) is a basis function, and X ϵ[δ_{pedal}, vₓ]^{T}.

At block 2054, calculate threshold values of the braking pedal positions and acceleration pedal positions according to the first linear regression model of the longitudinal accelerations. In one embodiment, according to the equation (6), the threshold value of the braking pedal positions δ_{pedal,brake,limit}=fₓ⁻¹(−a_{x,limit}, vₓ), the threshold value of the acceleration pedal positions δ_{pedal,accel,limit}=fₓ⁻¹(+a_{x,limit}, vₓ)

In other embodiments, establish a second linear regression model of the pedal positions according to a relation between the longitudinal accelerations and the velocities of the vehicle.

By switching dependent and independent variable, the relation between the longitudinal acceleration a_{y}, the pedal positions δ_{swa}, and the velocities vₓ of the vehicle 2 can also be expressed by the following equation (7):

δ_{pedal}=gₓ(aₓ, vₓ) (7)

In the equation (7), the function gₓ is monotonic and can be fitted into the second linear regression model. The second linear regression model can be expressed by the following linear fitting equation (8):

$${g}_{x} ( {a}_{x} , {v}_{x} ) = {θ}_{0} + {\sum }_{j = 1}^{n} {θ}_{j} {ψ}_{j} ( X ) . \qquad ( 8 )$$

In the equation (8), ψⱼ(X) is a basis function, X ϵ[aₓ, vₓ]^{T}.

In other embodiments, calculate threshold values of the braking pedal positions and acceleration pedal positions according to the second linear regression model of the pedal positions. In one embodiment, according to the equation (8), the threshold value of the braking pedal positions δ_{pedal,brake,limit}=gₓ(−a_{x,limit}, vₓ), the threshold value of the acceleration pedal positions δ_{pedal,accel,limit}=gₓ(+a _{x,limit}, vₓ).

At block 2055, calculate a threshold value of the pedal positions according to the threshold values of the braking pedal positions and acceleration pedal positions.

Due to respectively independent braking and acceleration system, there is always asymmetry at pedal position limits, that is, the threshold value of the braking pedal positions is different from the threshold value of acceleration pedal positions. The threshold value p of the pedal positions can be calculated by the following equation (9):

p=½(δ_{pedal,brake,limit}+δ_{pedal,accel,limit}) (9).

At block 2056, calculate the offset in the pedal axis according to the threshold values of the braking pedal positions and acceleration pedal positions. In one embodiment, the offset P_{c} in the pedal axis can be calculated by the following equation (10):

p_{c}=|δ_{pedal,brake,limit}−δ_{pedal,accel,limit}| (10).

At block 2057, determine the threshold value of the pedal positions to be the other one of the boundary limits of the ellipse boundary corresponding to the pedal positions. In one embodiment, the ellipse boundary can be determined according to the boundary limits and the offset in the pedal axis, that is, the threshold value q of the steering wheel angles, the threshold value p of the pedal positions, and the offset P_{c} in the pedal axis.

At block 206, obtain real-time input data and output data of the vehicle 2. In one embodiment, obtain the real-time input data and output data of the vehicle 2 within a second time period from the CAN bus. In one embodiment, the first predefined time period can also be a day, a week, or a month.

At block 207, calculate a first ratio of data points outside the boundary of the input regression model to total data points in the real-time input data, and a second ratio of data points outside the boundary of the output regression model to total data points in the real-time output data.

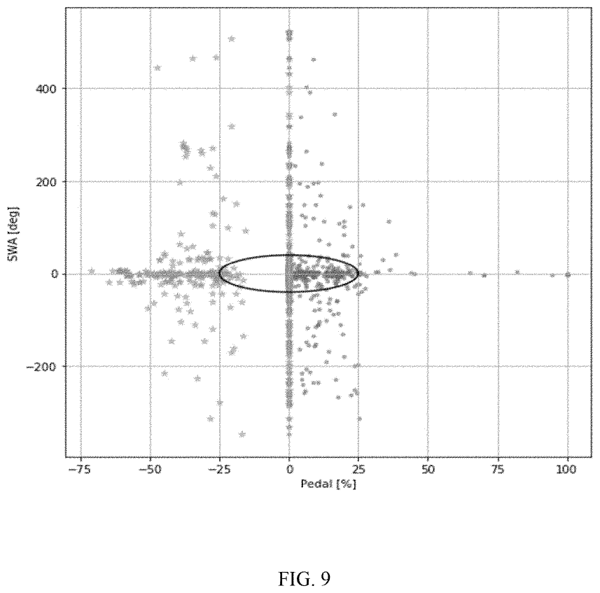

In one embodiment, the block 207 includes: determine the number of the total data points in the real-time input data and output data. Referring to FIG. 9, a group of obtained real-time input data at each time is regarded as a data point, the data point of the real-time input data includes a pedal position and a steering wheel angle, and can be expressed by (pedal position, steering wheel angle), such as (25%, 200°). The number of the total data points in the real-time input data are the number of the group of obtained real-time input data within the second predefined time period.

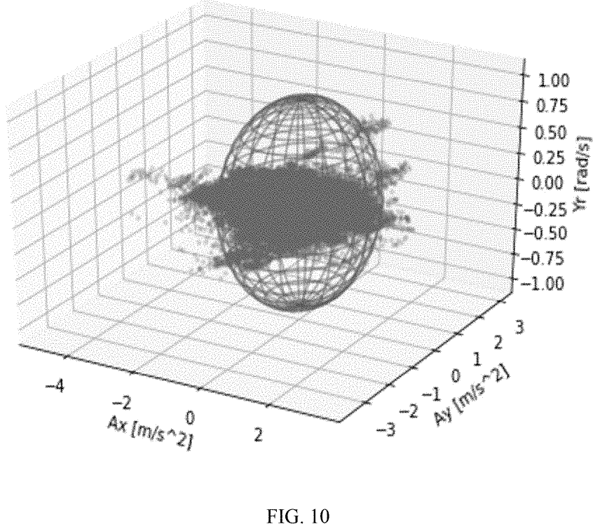

Referring to FIG. 10, in one embodiment, similarly, the number of the total data points in the real-time output data are the number of the group of obtained real-time output data within the second predefined time period. The data point of the real-time output data includes a longitudinal acceleration, a lateral acceleration, and a yaw rate, and can be expressed by (longitudinal acceleration, lateral acceleration, yaw rate), such as (2m/s², 1m/s², 0.25rad/s).

In one embodiment, the block 207 further includes: determine the number of the data points outside the boundary of the input regression model in the real-time input data, and the data points outside the boundary of the output regression model in the real-time output data. The number of the data points outside the boundary of the input regression model are determined according to the boundary limits a, b, and c of the ellipsoid boundary. The number of the data points outside the boundary of the output regression model are determined according to the boundary limits p and q of the ellipse boundary.

In one embodiment, the block 207 further includes: calculate the first ratio of the number of the data points outside the boundary of the input regression model to the number of the total data points in the real-time input data, and the second ratio of the number of the data points outside the boundary of the output regression model to the number of the total data points in the real-time output data. The first or second ratio can be calculated by the following equation (11):

$$Ratio = \frac{data \cdot points \cdot outside \cdot of \cdot boundary}{total \cdot data \cdot points} . \qquad ( 11 )$$

In the equation (9), the ratio is greater than 0 and is equal to or less than 1.

At block 208, score driving behavior of the driver of the vehicle according to the first ratio and the second ratio.

In one embodiment, the block 208 includes: determine a sum value of the product of the first ratio and a first predefined weight and the product of the second ratio and a second predefined weight to be a score of the driving behavior of the driver of the vehicle 2.

For example, the first predefined weight is assumed to be a, the second predefined weight is assumed to be β the score of the driving behavior of the driver of the vehicle 2 is calculated by the following equation (12):

Score_{driving behavior}=a·Ratio_{Input}+β·Ratio_{Output} (12)

In the equation (12), Ratio_{Input} is the first ratio, Ratio_{Output} is the second ratio, the first predefined weight a and the second predefined weight β are positive weights which can provide more flexibility on scoring driving behavior, and can be predefined and adjusted.

In other embodiments, the block 208 includes: determine a sum value or an average value of the first ratio and second ratio to be a score of the driving behavior of the driver of the vehicle.

In one embodiment, the method further includes: define driving style of the driver based on the score. For example, drivers with scores less than a first predefined value are identified as smooth, drivers with scores between the first predefined value and a second predefined value are identified as normal, and drivers with scores above the second predefined value as aggressive.

In one embodiment, the method further includes: define insurance policy of the driver according to the score or the driving style of the driver.

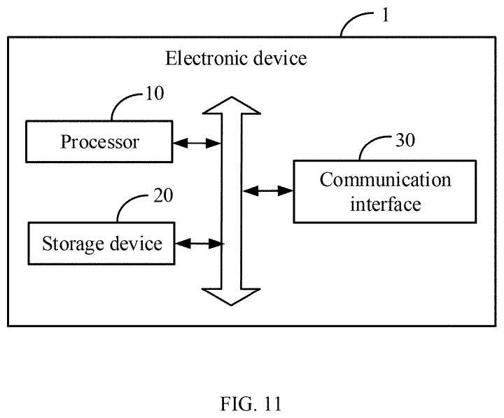

FIG. 11 illustrates the electronic device 1 in one embodiment. The electronic device 1 includes, but is not limited to, a processor 10, a storage device 20, and a communication interface 30. FIG. 11 illustrates only one example of the electronic device 1. Other examples can include more or fewer components than as illustrated or have a different configuration of the various components in other embodiments.

The processor 10 can be a central processing unit (CPU), a microprocessor, or other data processor chip that performs functions in the electronic device 1.

In one embodiment, the storage device 20 can include various types of non-transitory computer-readable storage mediums. For example, the storage device 20 can be an internal storage system, such as a flash memory, a random access memory (RAM) for the temporary storage of information, and/or a read-only memory (ROM) for permanent storage of information. The storage device 20 can also be an external storage system, such as a hard disk, a storage card, or a data storage medium.

The communication interface 30 can be an interface of a communication module, for example, an interface of a wireless communication module. In one embodiment, the communication interface 30 can communicate with the CAN bus of the vehicle 2.

The storage device 20 stores instructions, the processor 10 executes the instructions stored in the storage device 20, and the instructions can be used for implementing the method for scoring driving behavior using vehicle inputs and outputs provided in the embodiments of the present disclosure.

The processor 10 is configured to:

obtain historical input data and output data of the vehicle 2;

establish an output regression model of the vehicle according to the historical output data;

determine a boundary of the output regression model by calculating boundary limits of the output regression model;

establish an input regression model of the vehicle according to the historical input data;

determine a boundary of the input regression model by calculating boundary limits of the input regression model;

obtain real-time input data and output data of the vehicle 2;

calculate a first ratio of data points outside the boundary of the input regression model to total data points in the real-time input data, and a second ratio of data points outside the boundary of the output regression model to total data points in the real-time output data; and

score driving behavior of a driver of the vehicle 2 according to the first ratio and the second ratio.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being embodiments of the present disclosure.

What is claimed is:

1. An electronic device comprising:
at least one processor; and
a storage device coupled to the at least one processor and storing instructions for execution by the at least one processor to cause the at least one processor to:
obtain historical input data and output data of a vehicle;
establish an output regression model of the vehicle according to the historical output data;
determine a boundary of the output regression model by calculating boundary limits of the output regression model;
establish an input regression model of the vehicle according to the historical input data;
determine a boundary of the input regression model by calculating boundary limits of the input regression model;
obtain real-time input data and output data of the vehicle;
calculate a first ratio of data points outside the boundary of the input regression model to total data points in the real-time input data, and a second ratio of data points outside the boundary of the output regression model to total data points in the real-time output data; and
score driving behavior of a driver of the vehicle according to the first ratio and the second ratio.

2. The electronic device according to claim 1, wherein the output data at least comprises longitudinal accelerations, lateral accelerations, and yaw rates, and the at least one processor is further caused to:
establish a three-dimensional coordinate system according to the historical output data, wherein an x-axis of the three-dimensional coordinate system records the longitudinal accelerations, a y-axis of the three-dimensional coordinate system records the lateral accelerations, and a z-axis of the three-dimensional coordinate system records the yaw rates; and
determine the output regression model to be an ellipsoid boundary based on the three-dimensional coordinate system.

3. The electronic device according to claim 2, wherein the at least one processor is further caused to:
determine threshold values of the longitudinal accelerations and the lateral accelerations;
calculate a threshold value of the yaw rates according to the threshold value of the lateral accelerations and velocities of the vehicle; and
determine the threshold values of the longitudinal accelerations, the lateral accelerations, and the yaw rates to be boundary limits of the ellipsoid boundary.

4. The electronic device according to claim 3, wherein the input data at least comprises steering wheel angles, braking pedal positions, and acceleration pedal positions, and the at least one processor is further caused to:
establish a coordinate system according to the historical input data, wherein an x-axis of the coordinate system records pedal positions, and a y-axis of the coordinate system records the steering wheel angles; and
determine the input regression model to be an ellipse boundary based on the coordinate system.

5. The electronic device according to claim 4, wherein the at least one processor is further caused to:
calculate a threshold value of the steering wheel angles according to the threshold of the yaw rates, an inverse steering gear ratio of the vehicle, and a wheel span of the vehicle; and
determine the threshold value of the steering wheel angles to be one of boundary limits of the ellipse boundary corresponding to the steering wheel angles.

6. The electronic device according to claim 5, wherein the at least one processor is further caused to:
establish a first linear regression model of the longitudinal accelerations according to a relation between the pedal positions and the velocities of the vehicle; and
calculate threshold values of the braking pedal positions and acceleration pedal positions according to the first linear regression model of the longitudinal accelerations.

7. The electronic device according to claim 6, wherein the at least one processor is further caused to:
calculate the other one of the boundary limits of the ellipse boundary corresponding to pedal positions according to the threshold values of the braking pedal positions and acceleration pedal positions;
calculate an offset in a pedal axis according to the threshold values of the braking pedal positions and acceleration pedal positions; and
determine the boundary of the input regression model according to the boundary limits of the ellipse boundary corresponding to the steering wheel angles and the pedal positions, and the offset in the pedal axis.

8. The electronic device according to claim 5, wherein the at least one processor is further caused to:
establish a second linear regression model of pedal positions according to a relation between the longitudinal accelerations and the velocities of the vehicle; and
calculate threshold values of the braking pedal positions and acceleration pedal positions according to the second linear regression model of the pedal positions.

9. The electronic device according to claim 1, wherein the at least one processor is further caused to:
determine a sum value or an average value of the first ratio and second ratio to be a score of the driving behavior of the driver of the vehicle.

10. The electronic device according to claim 1, wherein the at least one processor is further caused to:
calculate a product of the first ratio and a first predefined weight corresponding to input data of the vehicle, and a product of the second ratio and a second predefined weight of the vehicle corresponding to output data; and
determine a sum value of the product of the first ratio and the first predefined weight and the product of the second ratio and the second predefined weight to be a score of the driving behavior of the driver of the vehicle.

11. A method for scoring driving behavior using vehicle inputs and outputs implemented in an electronic device comprising:
obtaining historical input data and output data of a vehicle;
establishing an output regression model of the vehicle according to the historical output data;
determining a boundary of the output regression model by calculating boundary limits of the output regression model;
establishing an input regression model of the vehicle according to the historical input data;
determining a boundary of the input regression model by calculating boundary limits of the input regression model;
obtaining real-time input data and output data of the vehicle;
calculating a first ratio of data points outside the boundary of the input regression model to total data points in the real-time input data, and a second ratio of data points outside the boundary of the output regression model to total data points in the real-time output data; and
scoring driving behavior of a driver of the vehicle according to the first ratio and the second ratio.

12. The method according to claim 11, wherein the output data at least comprises longitudinal accelerations, lateral accelerations, and yaw rates, and
steps of establishing an output regression model of the vehicle according to the historical output data comprises:
establishing a three-dimensional coordinate system according to the historical output data, wherein an x-axis of the three-dimensional coordinate system records the longitudinal accelerations, a y-axis of the three-dimensional coordinate system records the lateral accelerations, and a z-axis of the three-dimensional coordinate system records the yaw rates; and
determining the output regression model to be an ellipsoid boundary based on the three-dimensional coordinate system.

13. The method according to claim 12, wherein steps of determining a boundary of the output regression model by calculating boundary limits of the output regression model comprises:
determining threshold values of the longitudinal accelerations and the lateral accelerations;
calculating a threshold value of the yaw rates according to the threshold value of the lateral accelerations and velocities of the vehicle; and
determining the threshold values of the longitudinal accelerations, the lateral accelerations, and the yaw rates to be boundary limits of the ellipsoid boundary.

14. The method according to claim 13, wherein the input data at least comprises steering wheel angles, braking pedal positions, and acceleration pedal positions, and
steps of establishing an input regression model of the vehicle according to the historical input data comprises:
establishing a coordinate system according to the historical input data, wherein an x-axis of the coordinate system records pedal positions, and a y-axis of the coordinate system records the steering wheel angles; and
determining the input regression model to be an ellipse boundary based on the coordinate system.

15. The method according to claim 14, wherein steps of determining a boundary of the input regression model by calculating boundary limits of the input regression model comprises:
calculating a threshold value of the steering wheel angles according to the threshold of the yaw rates, an inverse steering gear ratio of the vehicle, and a wheel span of the vehicle; and
determining the threshold value of the steering wheel angles to be one of boundary limits of the ellipse boundary corresponding to the steering wheel angles.

16. The method according to claim 15, wherein steps of determining a boundary of the input regression model by calculating boundary limits of the input regression model further comprises:
establishing a first linear regression model of the longitudinal accelerations according to a relation between the pedal positions and the velocities of the vehicle; and
calculating threshold values of the braking pedal positions and acceleration pedal positions according to the first linear regression model of the longitudinal accelerations.

17. The method according to claim 16, wherein steps of determining a boundary of the input regression model by calculating boundary limits of the input regression model further comprises:
calculating the other one of the boundary limits of ellipse boundary corresponding to pedal positions according to the threshold values of the braking pedal positions and acceleration pedal positions;
calculating an offset in a pedal axis according to the threshold values of the braking pedal positions and acceleration pedal positions; and
determining the boundary of the input regression model according to the boundary limits of the ellipse boundary corresponding to the steering wheel angles and the pedal positions, and the offset in the pedal axis.

18. The method according to claim 15, wherein steps of determining a boundary of the input regression model by calculating boundary limits of the input regression model further comprises:
establishing a second linear regression model of pedal positions according to a relation between the longitudinal accelerations and the velocities of the vehicle; and
calculating threshold values of the braking pedal positions and acceleration pedal positions according to the second linear regression model of the pedal positions.

19. The method according to claim 11, wherein steps of scoring driving behavior of a driver of the vehicle according to the first ratio and the second ratio comprises:
determining a sum value or an average value of the first ratio and second ratio to be a score of the driving behavior of the driver of the vehicle.

20. The method according to claim 11, wherein steps of scoring driving behavior of a driver of the vehicle according to the first ratio and the second ratio comprises:
calculating a product of the first ratio and a first predefined weight corresponding to input data of the vehicle, and a product of the second ratio and a second predefined weight of the vehicle corresponding to output data; and
determining a sum value of the product of the first ratio and the first predefined weight and the product of the second ratio and the second predefined weight to be a score of the driving behavior of the driver of the vehicle.
